(19) United States
(12) Patent Application Publication
(10) Pub. No.: US 2006/0201443 A1
(43) Pub. Date: Sep. 14, 2006

(54) INTERLOCKING SWINE FLOOR

(75) Inventor: Norbert Borcherding, Dyersville, IA (US)

Correspondence Address: SHUTTLEWORTH & INGERSOLL, P.L.C., 115 3RD STREET SE, SUITE 500, P.O. BOX 2107, CEDAR RAPIDS, IA, 52406, US

(73) Assignee: DOUBLE L GROUP, LTD., Dyersville, IA (US)

(21) Appl. No.: 11/307,087

(22) Filed: Jan. 23, 2006

Related U.S. Application Data
(60) Provisional application No. 60/659,319, filed on Mar. 8, 2005.

(51) Int. Cl. A01K 1/01

(52) U.S. Cl. 119/529

(57) ABSTRACT

An interlocking flooring structure comprising first flooring sections having a series of tabs which are received by corresponding openings on adjacent flooring sections. In use, the tabs on the first flooring sections are received by the openings in the adjacent flooring sections to create a flooring structure.

This application claims the benefit of U.S. provisional patent application No. 60/659,319 filed Mar. 8, 2005 which is hereby incorporated by reference.

### BACKGROUND OF THE INVENTION

The present invention relates to interlocking floor sections for animal shelters such as farrowing houses. More particularly, the present invention relates to an improved farrowing house floor system wherein the plurality of interlocking floor sections are combined using tabs that fit into corresponding openings.

The swine production industry has evolved into a major farming enterprise wherein production occurs in modern confinement facilities. In the usual farrowing house arrangement, pens are placed adjacent to each other in two rows along the length of the farrowing house. A center aisle between the rows provides access to the pens, and side aisles at the rear of the pens can also be included. The flooring of the shelter is typically comprised of a plurality of interlocking sections which supports the pens and the animals. The interlocking sections comprise center sections and outer sections called creeps. The hogs usually lay on the center floor sections and feed the little pigs that lay on the outer floor sections. At least some of the interlocking floor sections are raised above the ground surface so as to form a pit beneath the flooring. The flooring is usually slotted to permit passage of the animals' waste through to the pit below. The slotted floors not only reduce or practically eliminate floor cleaning, but also greatly retard the spread of disease and parasites by allowing the rapid removal of excrement from the pens.

It is important that the floor sections be securely combined so they do not shift relative to each other as the hogs move around on top of the floor sections. Some farrowing house floor sections are secured to each other using “J” bolts. The problem with this technique is that it is time consuming for the farmer to place and tighten all the bolts on all the flooring sections, especially if it is a large hog farming operation having hundreds or thousands of flooring sections. Another problem with this method is that the “J” bolts usually stick up above the plane of the flooring sections which makes it difficult to clean the flooring sections because the “J” bolts tend to trap waste as the farmer sprays the floor sections.

Therefore, there is a need for a farrowing house flooring structure comprised of floor sections that quickly and easily combine with each other and are easy to clean, yet do not shift relative to each other as the hogs move around on top of the floor sections.

### SUMMARY OF THE INVENTION

The present invention is an interlocking flooring structure comprising first flooring sections having a series of tabs which are received by corresponding openings on adjacent flooring sections. As is known in the art, farrowing pens typically comprise interlocking floor sections which are raised above the ground surface so as to form a pit beneath the flooring. The flooring is usually slotted to permit passage of the animals' waste through to the pit below. The present invention comprises first flooring sections having tabs near their edges and adjacent flooring sections having openings near their edges that correspond to the first sections' tabs. In use, the first flooring sections are combined with the adjacent flooring section so that the tabs are received by the openings. In this manner, the flooring sections alternate to create a floor structure that can be as large as the farmer desires. The placement of the tabs into the openings prevents the sections from sliding relative to each other.

The present invention is beneficial because it provides for quick and efficient assembly or reassembly of a farrowing house floor. Further, since the openings are slightly larger than the tabs, the invention allows for normal expansion and contraction caused by seasonal temperature changes and different material expansion rates.

### BRIEF DESCRIPTION OF THE DRAWING

FIG. 1 is a perspective view showing the tabs on the first floor section and the openings on the adjacent floor sections;

FIG. 2 is a top view showing the tabs on the first floor section and the openings on the adjacent floor sections where a portion of the top surface of the adjacent floor section has been removed for clarity;

FIG. 3 is a bottom view of the first floor section showing the tabs at each corner of the floor section;

FIG. 4 is an end view showing the tabs extending downwardly from the first floor section.

### DESCRIPTION OF THE PREFERRED EMBODIMENT OF THE INVENTION

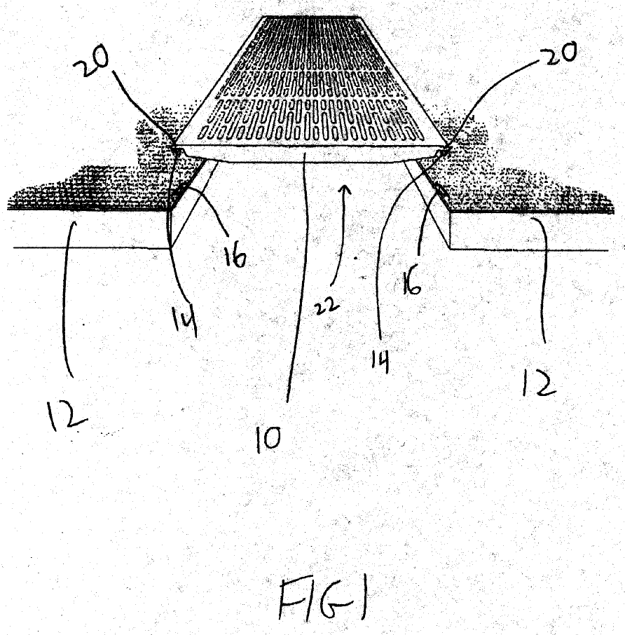

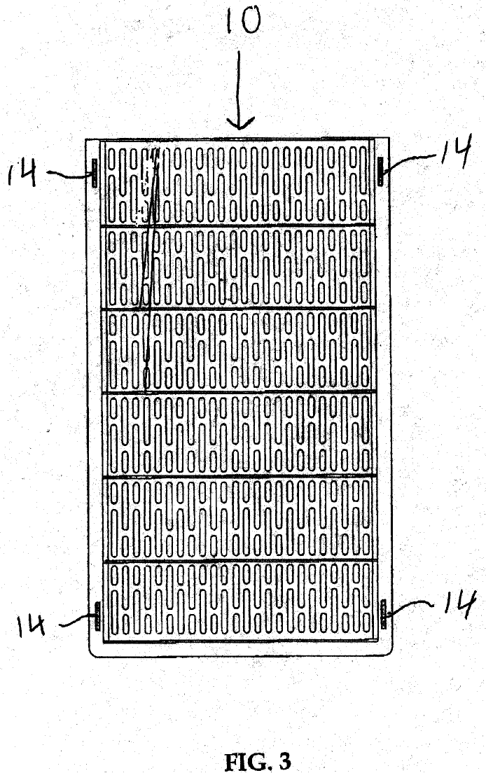

As shown in FIGS. 1-4, the present invention is an interlocking flooring structure comprising first flooring sections 10 having a series of tabs 14 which are received by corresponding openings 16 on adjacent flooring sections 12. As shown in FIG. 1, farrowing pens typically comprise interlocking floor sections 10, 12 which are raised above the ground surface so as to form a pit 22 beneath the flooring. The flooring is usually slotted to permit passage of the animals' waste through to the pit 22 below.

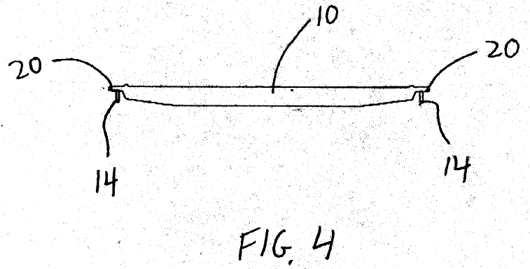

In the present invention, the first flooring sections 10 and adjacent flooring sections 12 can be made of any suitable material such as iron, steel, or plastic. In the preferred embodiment, the first flooring sections 10 are comprised of cast iron and the adjacent flooring sections 12 are comprised of galvanized steel. As seen best in FIGS. 1 and 4, the first floor section 10 of the present invention comprises several tabs 14. Although the tabs 14 are preferably at the corners of the first floor sections 10, they may extend from the first floor section 10 at any point near the edge of the first floor section 10. The tabs 14 are preferably welded to the bottom surface of the first floor section 10 so they extend downward at roughly a ninety degree angle relative to the horizontal surface of the floor section 10.

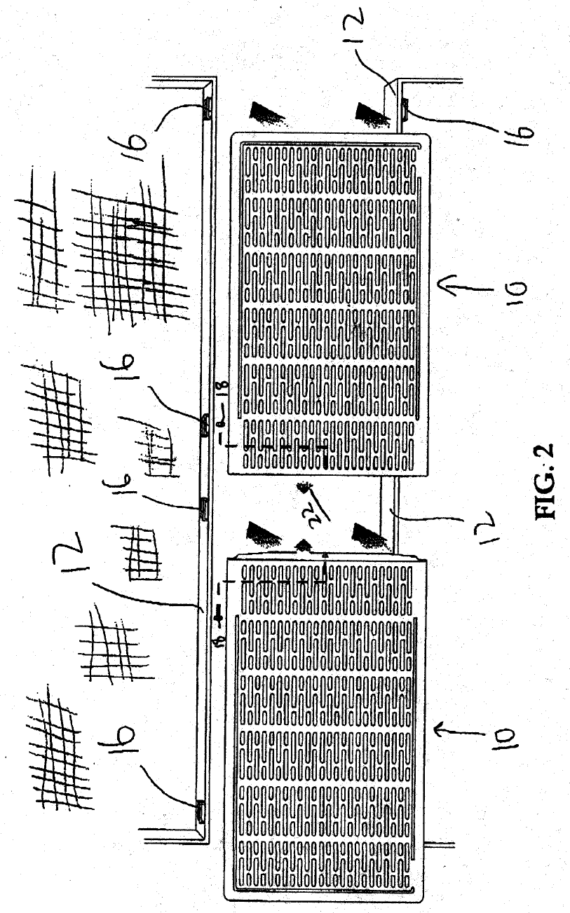

The openings 16 in the adjacent floor sections 12 may be positioned at any point near the edge of the adjacent floor sections 12 as long as they correspond with the tabs 14 of the first floor section 10. The openings 16 can be mere openings in the top surface of the adjacent flooring sections 12 as shown in FIG. 1, or the openings 16 may be separately combined to the frame of the adjacent flooring sections 12 as shown in FIG. 2, such as by welding. Further, if the openings 16 are separately combined, they may be combined on the inside of the adjacent flooring sections 12 as shown in FIG. 2, or combined to the outside of the adjacent flooring sections 12 (not shown). As seen best in FIG. 1, the top surface of the first flooring section 10 may slightly overlap with the top surface of the adjacent flooring sections 12 so that there is no space between the flooring sections 10, 12.

As seen in FIG. 2, two first flooring sections 10 can be combined end to end using a fastener 18 such as a bolt. This allows the construction of floors structures as large as the farmer desires. Preferably, in their combined position, the first flooring section 10 is elevated slightly above the adjacent flooring sections 12 because of the thickness of the edge of the first flooring section 10, illustrated by reference number 20 in FIGS. 1 and 4. This overlap adds structural integrity for the first floor section 10 because the edges 20 of the first floor section 10 can help support the entire first floor section 10, which is the section that the mother sow is usually occupying.

In use, the first flooring section 10 is placed next to the adjacent flooring section 12 so that the tabs 14 of the first flooring sections 10 are received by the openings 16 in the adjacent flooring section 12. In this manner, the flooring sections 10, 12 alternate to create a floor that can be as large as the farmer desires. The placement of the tabs 14 into the openings 16 keeps the flooring sections 10, 12 together by preventing the sections 10, 12 for sliding relative to each other. Further, since the openings 16 are slightly larger than the tabs 14, the invention allows for normal expansion and contraction caused by seasonal temperature changes and different material expansion rates.

Having thus described the invention in connection with the preferred embodiments thereof, it will be evident to those skilled in the art that various revisions can be made to the preferred embodiments described herein with out departing from the spirit and scope of the invention. It is my intention, however, that all such revisions and modifications that are evident to those skilled in the art will be included with in the scope of the following claims.

What is claimed is:

1. A slotted floor structure for animal enclosures comprising:
a first flooring section having a top portion and a bottom portion;
at least one tab extending downward from the first flooring section bottom portion;
an adjacent flooring section having at least one opening therein;
wherein the tab is received by the opening so as to combine the first flooring section with the adjacent flooring section.

2. The floor of claim 1 wherein first flooring section is comprised of cast iron.

3. The floor structure of claim 1 wherein the adjacent flooring section is comprised of galvanized steel.

4. The floor structure of claim 1 wherein the tabs extend downward from the first flooring section bottom portion at a ninety degree angle.

5. The floor structure of claim 1 wherein the openings are slightly larger than the tabs so as to allow for normal expansion and contraction caused by seasonal temperature changes.

6. The floor structure of claim 1 further comprising at least two first flooring sections combined by a fastener.

7. The floor structure of claim 1 wherein the openings are slightly larger than the tabs so as to allow for normal expansion and contraction caused by different material expansion rates.

8. The floor structure of claim 1 wherein the first flooring section comprises a plurality of tabs and the adjacent flooring section comprises a plurality of corresponding openings.

9. A slotted floor structure for animal enclosures comprising:
a first flooring section having a top portion, a bottom portion, and two edge portions extending the length of the first flooring section;
at least one tab extending downward from each edge portion of the first flooring section;
an adjacent flooring section having at least one opening therein;
wherein the tabs are received by the openings so as to combine the first flooring section with the adjacent flooring section;
wherein each first flooring section edge portion rests on and is supported by the top of the adjacent flooring sections when the sections are combined.

10. A slotted floor structure for animal enclosures comprising:
a plurality of first rectangular flooring sections having a top portion and a bottom portion;
at least one tab extending downward from each corner of the bottom portion of each of the first flooring sections;
a plurality of rectangular adjacent flooring sections each having an opening at each section's corner;
wherein the tabs are received by the openings so as to combine the plurality of first flooring sections with the plurality of adjacent flooring sections.
